(19) United States
(12) Patent Application Publication
(10) Pub. No.: US 2014/0233290 A1
(43) Pub. Date: Aug. 21, 2014

(54) INVERTER SYSTEM AND DRIVING METHOD FOR AN INVERTER SYSTEM

(71) Applicant: Robert Bosch GmbH, Stuttgart (DE)

(72) Inventors: Konstantin Spanos, Wildberg (DE); Hartmut Steinbuch, Riederich (DE)

(21) Appl. No.: 14/183,629

(22) Filed: Feb. 19, 2014

(30) Foreign Application Priority Data
Feb. 19, 2013 (DE) 10 2013 202 649.8

(51) Int. Cl. H02M 7/5387

(52) U.S. Cl. CPC H02M 7/5387
USPC 363/131

(57) ABSTRACT

The present invention provides optimized driving of an inverter device. The inverter of such an inverter device may alternatively be driven in two-level operation or in three-level operation. Through a suitable selection of the driving method, the semiconductor losses in the inverter may be minimized and the thermal loading of the components used may be controlled in a targeted manner. Using the provided operating method for an inverter, more efficient and more protective inverter operation is possible, even at low output voltages and highly inductive or capacitive loading.

### BACKGROUND OF THE INVENTION

The present invention relates to an inverter system and a driving method for operating an inverter system.

Electric inverters which generate a single-phase or multiphase AC voltage from a DC voltage are known. For example, such inverters are used to feed electric energy from regenerative energy sources such as a photovoltaic system into an electric power network. Furthermore, inverters are also used, for example, in uninterruptible power supplies (UPSs). In addition, inverter systems are also used for controlling electric drives, for example, in electric vehicles.

In the design of inverter circuits, a distinction is made between two-point circuits or two-level circuits on the one hand and three-point circuits or three-level circuits on the other hand. FIG. 1 shows an example of a two-level circuit of a single-phase inverter. At the input of this inverter, the intermediate circuit voltage U_{ZK} is present between the points U+ and U−. The targeted driving of the two semiconductor switches V₁₀ and V₂₀ causes either the positive voltage U+ or the negative voltage U− to be present at the output A. Flyback diodes D10 and D20, which conduct current in the event of flyback, are respectively arranged parallel to the two semiconductor switches V₁₀ and V₂₀.

Furthermore, three-level circuits are capable of setting three voltage levels at the output. In addition to the positive voltage U+ and the negative voltage U−, a neutral mid-voltage may also be applied at the output of the inverter. By using a three-level circuit, the switching losses in the inverter may thus be reduced. In addition, such three-level circuits have a lower harmonic content of the output voltage in comparison to two-level circuits, even at a low switching frequency. Since conventional three-level circuits require a current flow of the load current through at least two semiconductor valves, the topology of the bridge arm (second-order NPC, NPC-T structure) has proved to be expedient with flyback. This circuit arrangement is known, for example, from the publication DE 10 2010 008 426 A1. This publication discloses an NPC (neutral-point-clamped) inverter having a relief network.

At high output voltages and a magnitude of cos(Φ) approaching 1, three-level inverter circuits are superior to two-level circuits with respect to the loading of the semiconductor switching elements, since, in this case, the flyback path of the circuits is only relatively lightly loaded. However, if a relatively low output voltage is to be produced and/or a large component of apparent power must be provided by the inverter, which corresponds to a cos(Φ) having a low magnitude, the semiconductor components in the flyback path of the inverter contribute strongly to the current conduction. Substantial semiconductor surfaces are therefore required, in particular since two semiconductors act in series during flyback. The losses of the inverter increase greatly at low output voltages and/or a relatively small magnitude of cos(Φ). In addition to lower efficiency, these losses also result in thermal loading of the inverter, thus requiring increased cooling and also negatively effect the service life of the inverter.

Therefore, there is a need for an inverter system which has losses which are as low as possible for all operational cases and thus which loads the semiconductor components as little as possible.

### SUMMARY OF THE INVENTION

According to one aspect, the current invention creates a driving method for an inverter having at least two different operating modes, wherein the driving method drives the inverter in two-level operation in a first operating mode and drives the inverter in three-level operation in a second operating mode.

According to a further aspect, the present invention creates an inverter system having an inverter which is designed to output an AC voltage; and a control device which is designed to drive the inverter in two-level operation in a first operating mode and to drive the inverter in three-level operation in a second operating mode.

One idea of the present invention is to adjust the operating mode of an inverter in a dynamic manner. In particular, during the operation of an inverter, switching takes place between two-level operation and three-level operation. The inverter may thus be operated in an optimal manner according to the respective basic conditions.

One advantage is that by adjusting the operating mode in the inverter according to the present invention, each operating mode may be adjusted in such a way that the semiconductor components of the inverter are loaded as little as possible. In particular, in each case, such an operating mode may be selected in which the currents in flyback operation also cause loading of the semiconductor components which is as low as possible.

One additional advantage is that by adjusting the operating mode according to the present invention, the switching losses within the inverter may be reduced. The efficiency of the inverter thus increases. In addition, reducing the losses within the inverter also results in lower thermal loading. The semiconductor components are thus protected and their service life is increased.

According to one specific embodiment of the driving method according to the present invention, the operating mode is selected as a function of at least one of the parameters output voltage, output current, apparent power to be provided, harmonic content of the output voltage and thermal loading of the inverter. Whereas three-level operation results in higher semiconductor loading than two-level operation, in particular at relatively low output voltages, this effect reverses with increasing output voltage. Thus, by selecting the operating mode as a function of the output voltage, the optimal operating mode for the inverter circuit may be selected. By taking into account the thermal loading within the inverter, excessive thermal loading of individual components may be avoided by selecting the corresponding operating mode in a targeted manner. In the most advantageous case, a virtually uniform operating temperature may thus be set for all components. Among other things, this results in an increase in the service life of the inverter. Likewise, by taking into account the output current, the apparent power to be provided and the permitted harmonic content of the output voltage in a targeted manner, optimization of the operating parameters may be achieved.

According to one specific embodiment, the first operating mode and the second operating mode of the inverter are selected in an alternating manner. By alternating the operation of the inverter in two-level operation and three-level operation, it is possible to achieve particularly uniform loading of all components used, thereby avoiding excessive stress on individual components.

According to another specific embodiment, the inverter is operated in a first operating mode having a first switching frequency, and the inverter is operated in a second operating mode having a second switching frequency which is different from the first switching frequency. An optimized switching frequency may thus be used for each of the two operating modes.

According to one specific embodiment, the inverter of the inverter system is designed as a three-level neutral-point-clamped inverter. The inverter is preferably designed as a second-order neutral-point-clamped inverter. Such inverters have particularly low losses and thus high efficiency.

In one specific embodiment, the inverter system has a multiphase inverter. Such multiphase inverters are particularly suitable, for example, for driving multiphase electric drives and/or for feeding electric energy into a three-phase network or the like.

One specific embodiment of the present invention comprises an inverter system which is provided for feeding energy into an electric power network or for improving the network quality.

One additional specific embodiment of the present invention comprises an electric drive having an inverter system according to the present invention. Electric drives in particular also require relatively low output voltages and/or operation having a cos(Φ) of relatively low magnitude. By operating the inverter system according to the present invention, particularly efficient driving may be achieved.

The present invention furthermore comprises a vehicle, in particular a hybrid or electric vehicle, having an electric drive which is driven by an inverter system according to the present invention.

### BRIEF DESCRIPTION OF THE DRAWINGS

Additional features and advantages of specific embodiments of the present invention result from the following description with reference to the included drawings.

FIG. 1 shows a schematic representation of a circuit for a two-level inverter;

FIG. 2 shows a schematic representation of a three-level-inverter system based on one specific embodiment of the present invention;

FIG. 3 shows a diagram for the schematic representation of the relationship between the output voltage of an inverter and the semiconductor loading; and

FIG. 4 shows a schematic representation of a pulse pattern at the output of an inverter according to one specific embodiment of the present invention.

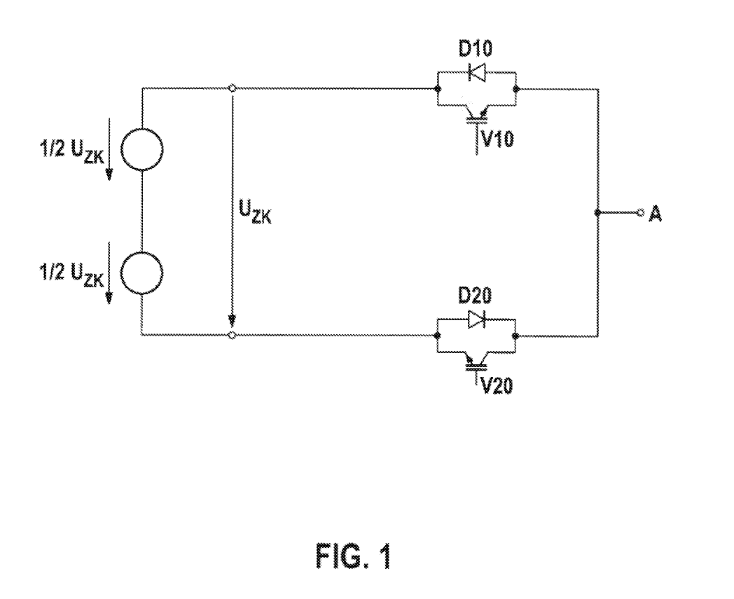

### DETAILED DESCRIPTION

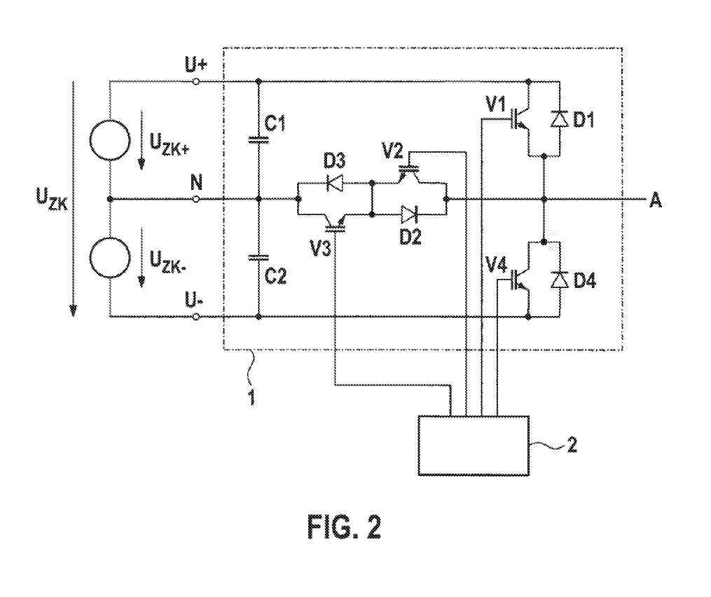

FIG. 2 shows one embodiment of a three-level inverter by way of example. The upper bridge arm of the inverter is connected to the terminal U+ for the positive input voltage U_{ZK+}. The lower bridge arm is connected to the terminal U− for the negative input voltage U_{ZK-}. The center bridge arm is connected to the input terminal N for the center tap of the input voltage. Half the intermediate circuit voltage U_{ZK} is respectively applied between the terminal U+ and N and between the terminal N and U− as the input voltage U_{ZK+} and U_{ZK-}. The inverter 1 has a first intermediate-circuit capacitor C1 between the terminal U+ and the terminal N, and a second intermediate-circuit capacitor C2 between the terminal N and U−. The inverter 1 furthermore has the four switching elements V1 to V4, which are driven via a control device 2. A pulsed output voltage is thus present at the output terminal A. The diodes D1 to D4 are each connected inversely parallel to the four switching elements V1 to V4. The first switching element V1 and the diode D1 are situated in the upper bridge arm between the input terminal U+ and the output A. The fourth switching element V4 including the corresponding diode D4 is situated in the lower bridge arm between the input terminal U− and the output A. The switching element V2 including the diode D2 and the switching element V3 including the diode D3 are situated in series in the center bridge arm between the terminal N and the output A.

All types of suitable switching elements are possible as switching elements V1 to V4. Semiconductor switching elements such as insulated-gate bipolar transistors (IGBTs) are particularly suitable as switching elements. Alternatively, all types of other switching elements which enable corresponding inverter operation are of course also possible.

Generally, the inverter 1 may initially be driven in three-level operation in its depicted form. The control device 2 drives the switching elements V1 to V4 in such a way that either the positive intermediate circuit voltage U_{ZK+}, the negative intermediate circuit voltage U_{ZK-} or the neutral center voltage is present at the output A of the inverter. In this three-level operational mode, the semiconductor components used, in particular in the center arm, are very heavily loaded, particularly at output voltages which are relatively low in comparison to the intermediate circuit voltage. At relatively low output voltages, the center arm is active for a period which is longer than average. Since the current must flow through a switching element V2 or V3 and also simultaneously via the corresponding diode D2 or D3 in this center arm, particularly high loading of the involved semiconductor components results in this case.

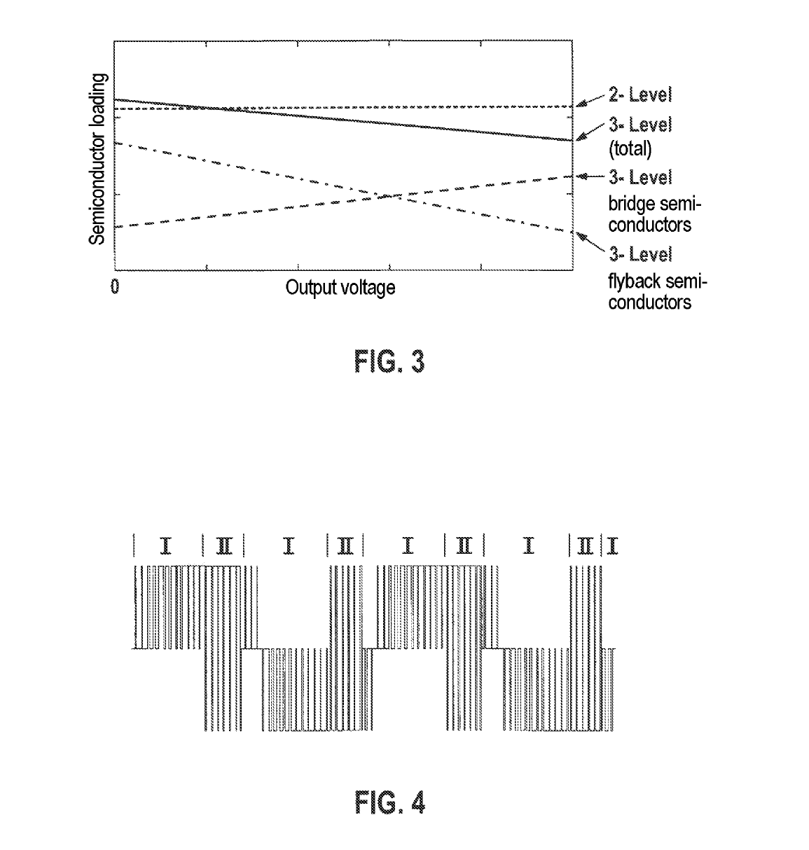

FIG. 3 shows a diagram which depicts the relationship between the output voltage and the loading of the semiconductor components in an inverter. As may be seen, very high loading of the flyback semiconductors occurs in particular at low output voltages in three-level operation. This results in the sum of the loading of the semiconductors at very low output voltages being greater in three-level operation than in two-level operation.

Therefore, to reduce the semiconductor loading in the inverter 1, the inverter 1 may alternatively also be operated in two-level operation. The control device 2 does not drive the switching elements V2 and V3 here. In fact, only the switching elements V1 and V4 are driven in two-level operation. Thus, in two-level operation, either the positive intermediate circuit voltage U_{ZK+} or the negative intermediate circuit voltage U_{ZK-} is present at the output A of the inverter 1. Since the switching elements V2 and V3 and the diodes D2 and D3 in the center arm are not included in the current path during two-level operation, these components are also not loaded in two-level operation.

As may be seen in FIG. 3, the resulting total semiconductor loading is lower in two-level operation than in three-level operation, in particular at relatively low output voltages to be set at the inverter. Thus, for example, depending on the output voltage to be set, the inverter 1 may be driven by the control device 2 either in two-level operation or in three-level operation, depending on which operating mode causes the lower semiconductor loading.

In addition, the flyback arms of the inverter are highly stressed, in particular at a relatively low magnitude of cos(Φ), i.e., under high inductive or capacitive loading. High inductive loading occurs, for example, when driving electrical drives. Such drives exist, for example, in electric vehicles. However, other inductive or capacitive loading also leads to high currents in the flyback arms, thus resulting in corresponding loading of the involved semiconductor components.

Due to the previously described effects, for example, the operation of the inverter for relatively low output voltages and/or having highly inductive or capacitive loads, relatively high loading of individual components may occur. This high loading results in strong thermal heating of the respective components. Excessive heating of the components in turn results in a drastic reduction of the service life. In order to counteract such excessive heating of individual components, the concept according to the present invention of switching between two-level operation and three-level operation may be used to reduce excessive thermal loading of individual components. By switching in a targeted manner between the two operating modes, it is possible to change from one operating mode to the other and thus to distribute the loading across multiple components in a targeted manner. Individual components may be protected from excessive heating. Thus, for example, by alternating operation between two-level operation and three-level operation, the thermal power dissipation may be distributed uniformly across all components. For this, it is possible, for example, to create a mathematical model and, based on power dissipation of the individual components thus theoretically calculated, to switch back and forth between the operating modes in such a way that all components heat up as uniformly as possible. Alternatively, it is also possible to integrate temperature sensors (not shown) into the inverter and thus to switch from one operating mode to an alternative operating mode in the event of a measured excessive temperature increase. By controlling the inverter for heating all components uniformly, it is possible to avoid excessive aging of individual components due to an excessive temperature increase and therefore to increase the service life of the inverter.

Switching between the individual operating modes, i.e., two-level operation and three-level operation, does not necessarily have to occur after each pulse period. It is sufficient to carry out switching between the individual operating modes frequently enough that an approximately constant operating temperature arises due to the thermal inertia of the components.

During alternating operation in two-level operation and three-level operation, a balanced ratio of the two operating modes is also not absolutely necessary, i.e., the inverter does not have to be operated at 50% in two-level operation and at 50% in three-level operation. Depending on the other basic conditions, other mixture ratios of the two operating modes are also possible. The ratio of the two operating modes may be adjusted to the respective operating point in order to optimize the loading of the semiconductors or to enable loss-optimized operating modes for the respective operating points.

Operation in two-level mode increases the harmonic content of the output voltage. These expected harmonics of the output voltage of the inverter may also be taken into account when setting the mixture ratio of the two operating modes and the chronological sequence. In addition, the ratio of the two operating modes or the selection of only one of the two modes may, for example, be made dependent on the magnitude of the output current.

For example, if the inverter is operated under light-load conditions in which only relatively low currents flow, even an operating mode which is rather unfavorable will not cause excessive heating of the inverter in this case. Therefore, in such a case, three-level operation may be selected continuously, even for relatively low output voltages.

In summary, the following must therefore be taken into account for the selection of the respective operating mode or for the selection of the mixture ratio in alternating operation:

Magnitude of the output current: If output currents are relatively low, even unfavorable operating modes do not result in excessive heating of the inverter. Therefore, if output currents are low, even an operating mode having greater losses in the inverter may be accepted.

Inductive/capacitive output load: If the loading of the inverter has a relatively small magnitude of cos(101 ), relatively high flyback currents are to be expected. These flyback currents must also be taken into account when selecting the operating mode.

Harmonic content of the output voltage: As mentioned earlier, the harmonic content in two-level operation is higher than in three-level operation. Therefore, three-level operation is preferable for a lower harmonic content of the output voltage.

Expected losses and inverter efficiency.

Minimization of temperature fluctuation in the individual semiconductors: Controlled switching between the operating modes makes it possible to keep all components used during the operation period at an approximately constant temperature, which has a positive effect on the life expectancy of the inverter.

Output voltage to be set: As may be seen in FIG. 3, the loading of the components varies as a function of the output voltage to be set of the inverter.

At particularly low output frequencies, the loading of the switching elements can no longer be averaged over one period. In this case, the switching elements must be measured to the worst case of the instantaneous values. In three-level operation, the electrical loading is concentrated here on the semiconductor pair in the flyback circuit. By alternating operation between two-level operation and three-level operation, a high degree of load relief may thus be achieved.

However, the distribution of three-level operation and two-level operation does not have to take place homogeneously along the electrical angle of the output voltage. In particular at very low output frequencies, the mixed operation may be distributed differently over the electrical angle of the fundamental component of the output voltage, in order to achieve optimization.

The previously described operation of an inverter system may be used with numerous known modulation methods according to the related art for the respective individual operating modes. Such methods or phase positions of the modulation carriers are preferably to be used which require no additional switching actions during the transition between the two operating modes, in order to avoid additional switching losses.

However, this does not necessarily mean that the same switching frequency must generally be used in both two-level operation and three-level operation. It is also possible to select a different switching frequency separately for two-level operation and three-level operation. If different switching frequencies are selected for two-level operation and three-level operation, integer ratios between the switching frequencies are preferably to be selected, so that a low-loss transition between the operating modes may be ensured.

FIG. 4 shows a schematic representation of an exemplary pulse pattern at the output of an inverter according to the present invention. During the time periods I, the inverter is in three-level operation, i.e., the output voltage is switched between the neutral reference potential and the positive or negative intermediate circuit voltage. During the time periods II, the inverter is in two-level operation, i.e., the output voltage is switched back and forth exclusively between the positive and negative intermediate circuit voltage.

As described earlier, the operation of an inverter according to the present invention having switching between two-level operation and three-level operation may be used for the generation of a single-phase AC voltage. However, in addition, it is also possible to use the method according to the present invention on multiphase inverters as well, for example, a three-phase inverter. Thus, for example, feeding into a three-phase network may be carried out. It is also possible to use a multiphase inverter to drive a corresponding multiphase electric drive.

In summary, the present invention relates to optimized driving of an inverter device. The inverter of such an inverter device may alternatively be driven in two-level operation or in three-level operation. Through a suitable selection of the driving method, the semiconductor losses in the inverter may be minimized and the thermal loading of the components used may be controlled in a targeted manner. Using the provided operating method for an inverter, more efficient and more protective inverter operation is possible, even at low output voltages and highly inductive or capacitive loading.

1. A method for driving an inverter (1) having at least two different operating modes, the method comprising:
driving the inverter (1) in a two-level operation in a first operating mode; and
driving the inverter (1) in a three-level operation in a second operating mode.

2. The method for driving an inverter (1) according to claim 1, further comprising selectings the operating mode as a function of at least one of an output voltage, an output current, an apparent power to be provided, a harmonic content of the output voltage and a thermal loading of the inverter (1).

3. The method for driving an inverter (1) according to claim 1, wherein the first operating mode and the second operating mode are selected in an alternating manner.

4. The method for driving an inverter (1) according to claim 1, wherein the first operating mode has a first switching frequency, and the second operating mode has a second switching frequency which is different from the first switching frequency.

5. An inverter system, comprising:
an inverter (1) configured to output an AC voltage; and
a control device (2) configured to drive the inverter (1) in a two-level operation in a first operating mode and to drive the inverter (2) in a three-level operation a second operating mode.

6. The inverter system according to claim 5, wherein the inverter (1) is a three-level neutral-point-clamped inverter.

7. The inverter system according to claim 6, wherein, wherein the three-level neutral-point-clamped inverter is confined as a second-order neutral-point-clamped inverter.

8. The inverter system according to claim 5, wherein the inverter system has a multiphase inverter.

9. The inverter system according to claim 5, which is provided for feeding energy into an electric power network.

10. The inverter system according to claim 5, which is provided for improving the network quality.

11. An electric drive having an inverter system according to claim 5.

12. A vehicle having an electric drive according to claim 11.
